(19) United States
(12) Patent Application Publication
(10) Pub. No.: US 2014/0123956 A1
(43) Pub. Date: May 8, 2014

(54) CONTROL DEVICE FOR DIRECT INJECTION ENGINE

(71) Applicant: Yoshinobu Arihara, Hitachinaka (JP)

(72) Inventor: Yoshinobu Arihara, Hitachinaka (JP)

(73) Assignee: Hitachi Automotive Systems, Ltd.

(21) Appl. No.: 14/129,782

(22) PCT Filed: Jun. 28, 2012
(86) PCT No.: PCT/JP2012/066575

§ 371 Date: Dec. 27, 2013

(30) Foreign Application Priority Data
Jun. 30, 2011 (JP) 2011-146265

(51) Int. Cl. F02D 41/30

(52) U.S. Cl. CPC F02D 41/30
USPC 123/478

(57) ABSTRACT

The present invention provides a control device for a direct injection engine, capable of reducing the amount of fuel adhesion on a piston crown and a cylinder bore wall surface and improving homogeneity of a fuel-air mixture inside the cylinder, thereby reducing the particulate number of emitted PM. The fuel injection is inhibited for a period in which a lift position of an intake valve is within a predetermined range in a single combustion cycle, more specifically, during the period in which the lift position of the intake valve is located from a middle lift position to the vicinity of a maximum lift position.

### TECHNICAL FIELD

The present invention relates to a control device for a direct injection engine including a fuel injector that directly injects fuel into a cylinder (inside a combustion chamber).

### BACKGROUND ART

Recently, in a standpoint of environmental preservation, vehicles (automobiles) are demanded to reduce combustion waste gases (exhaust gases) which is to be greenhouse gases, carbon monoxide (CO), hydrocarbon (HC), nitrogen oxide (Nox), etc. contained in the combustion waste gases, and a particulate number of emitted particulate matters (hereinafter referred to as “PM”) (as a whole, referred to as “improvement of emission performance”), and to reduce fuel consumption (improvement of fuel consumption). To accomplish such improvements of emission performance and fuel consumption as well as improvement of engine output, direct injection engines have been developed, whereby a fuel injector jets the fuel directly into a combustion chamber of each cylinder.

In the direct injection engine, the jetted fuel may adhere on a piston crown or a cylinder bore wall surface depending on the fuel injection timing.

In the case where an amount of the fuel that adheres or resides on the cylinder bore wall surface is large, the fuel may not be completely vaporized during the time until ignition, and consequently unburnt gas tends to increase. For this reason, a technology is disclosed, for example, in PTL 1 or PTL 2, in which the fuel injection timing (generally indicating the timing to “start” the fuel injection) from a fuel injector in an intake stroke is changed such that the fuel is spread over a piston crown so as to be easily vaporized in the case where a temperature of the cylinder bore wall surface is low.

Further, another technology is disclosed in PTL 3, in which a fuel quantity in each injection is reduced by executing the fuel injection a plurality of times in a single combustion cycle (split injection). With this configuration, the amount of the fuel adhering on the cylinder bore wall surface is reduced, and an interval between a precedent injection timing and a subsequent injection timing (hereinafter, referred to as “injection interval”) is kept substantially constant by a crank angle. More specifically, spray is dispersed by setting the injection interval long when the rotation speed is low and also by setting the injection interval short when the rotation speed is high.

In recent years, there is a growing need to reduce, particularly, the particulate number of the particulate matters (hereinafter referred to as “PM”) emitted from the direct injection engine.

### CITATION LIST

### Patent Literatures

PTL 1: Japanese Patent Application Laid-Open No. 2009-102997

PTL 2: Japanese Patent Application Laid-Open No. 2009-102998

PTL 3: Japanese Patent Application Laid-Open No. 2002-161790

### SUMMARY OF INVENTION

### Technical Problem

In the direct injection engine, increase or decrease of the particulate number of the emitted PM is involved with the amount of the fuel adhesion on the piston crown and the cylinder bore wall surface, and homogeneity of a fuel-air mixture inside the cylinder.

The fuel adhesion on the piston crown and the cylinder bore wall surface is heavily affected by the fuel injection timing. When the fuel injection timing is too advanced, the amount of the fuel adhering and residing on the piston crown is increased, and when the fuel injection timing is too delayed, the amount of the fuel adhering and residing on the cylinder bore wall surface is increased. The larger the amount of the fuel adhesion on the piston crown and the cylinder bore wall surface is, the more the particulate number of the emitted PM is increased.

Additionally, the particulate number of the emitted PM sensitively reacts with concentration of the fuel-air mixture. The particulate number of the emitted PM is greatly affected by not only an average concentration of the fuel-air mixture but also homogeneity (mixing state of air and fuel) of the fuel-air mixture inside the cylinder. To improve the homogeneity of the fuel-air mixture inside the cylinder, it is known to intensify an air flow (tumble vertical swirl) flowing into the cylinder. To intensify the tumble and improve the homogeneity of the fuel-air mixture inside the cylinder, the timing of air flow and the timing of the fuel injection into the cylinder are important.

The prevent invention is achieved in view of the above-described problems, and an object of the present invention is to provide a control device for a direct injection engine capable of suppressing the fuel adhesion on the piston crown and the cylinder bore wall surface and improving the homogeneity of the fuel-air mixture inside the cylinder, thereby reducing the particulate number of the emitted PM.

### Solution to Problem

To achieve the above-mentioned object, a control device for the direct injection engine according to the present invention includes a split injection control means configured to execute the fuel injection a plurality of times in a single combustion cycle, and the split injection control means inhibits the fuel injection for a period in which a lift position of an intake valve is within a predetermined range in a single combustion cycle.

### Advantageous Effects of Invention

In the control device for the direct injection engine according to the present invention, the fuel is injected in a plurality of split times in a single combustion cycle. With this configuration, homogeneity of the fuel-air mixture inside the cylinder may be improved and the particulate number of the emitted PM can be reduced because the fuel injection is inhibited for the period in which the lift position of the intake valve is within the predetermined range in a single combustion cycle, more specifically, the period in which the tumble is weakened by the jetted fuel spray inside the cylinder.

### BRIEF DESCRIPTION OF DRAWINGS

FIG. 1 is a schematic configuration diagram illustrating an embodiment of a control device according to the present invention as well as a direct injection engine in which the embodiment is applied.

FIG. 2 is a diagram illustrating an internal configuration of an engine control module illustrated in FIG. 1 and input and output relations thereof.

FIG. 3 is a diagram illustrating a relation between a frequency of split injection and a particulate number of emitted PM.

FIG. 4 is a diagram illustrating a relation between a split injection interval and the particulate number of the emitted PM.

FIG. 5 is a diagram illustrating a relation among fuel injection start timing, tumble strength inside a cylinder, and the particulate number of the emitted PM.

FIG. 6 is a flowchart of operations in controlling the split injection according to an embodiment of the present invention.

FIG. 7 is a flowchart of detailed operations in step 607 (calculation of an injection pulse width in each injection of the split injection) in FIG. 6.

FIG. 8 is a flowchart of detailed operations in step 608 (calculation of an injection start timing in each injection of the split injection) in FIG. 6.

FIG. 9 is a diagram illustrating a map function to calculate the injection start timing in FIG. 7.

FIG. 10 is an explanatory diagram of an example of controlling the split injection according to an embodiment of the present invention.

FIG. 11 is an explanatory diagram of another example of controlling the split injection according to an embodiment of the present invention.

FIG. 12 an explanatory diagram of still another example of controlling the split injection according to an embodiment of the present invention.

### DESCRIPTION OF EMBODIMENTS

An embodiment of the present invention will be described below with reference to the drawings.

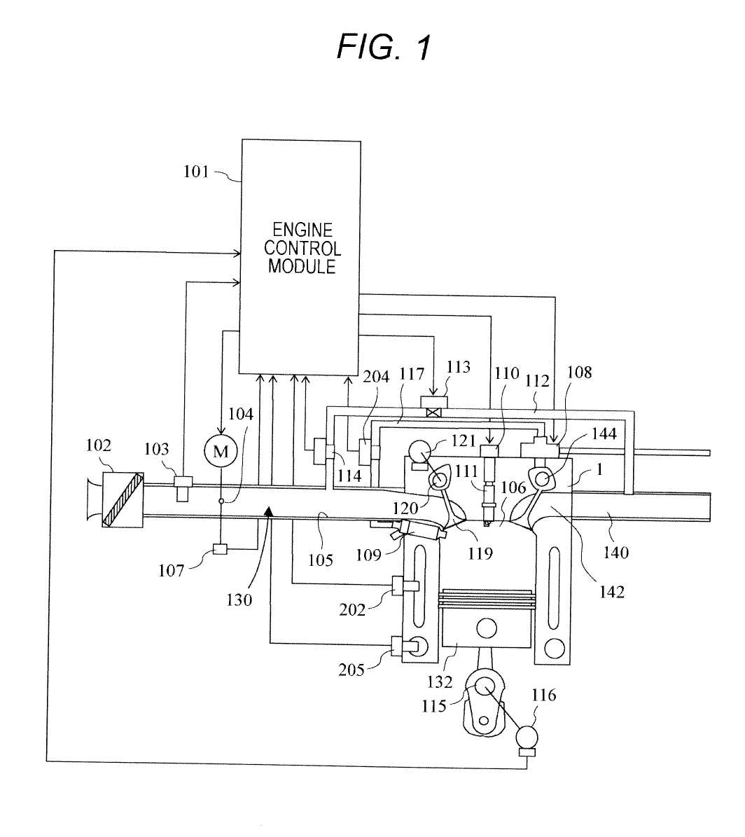

FIG. 1 is a schematic configuration diagram illustrating an embodiment of a control device according to the present invention as well as a direct injection engine in which the embodiment is applied.

A direct injection engine 1 illustrated in the drawing is, for example, an in-line 4-cylinder gasoline engine including four cylinders (#1, #2, #3, #4), in which intake air is introduced from an inlet of an air cleaner 102 forming an uppermost stream section of an intake air passage 130, and the air passes through an air flow sensor 103 and a throttle valve 104, and then is distributed to an intake air manifold (manifold) 105 connected with each cylinder, and also to an intake air port. Subsequently, the air is taken into a combustion chamber 106 defined above a piston 132 via an intake valve 119 which is opened and closed by an intake camshaft 120 provided with a variable valve timing mechanism (not shown).

After primary pressurization is applied to the fuel by a fuel feed pump (not shown), secondary pressurization is applied to the fuel to have higher pressure by a high pressure fuel pump 108 driven by an exhaust camshaft 144. Then, the fuel is supplied to a fuel injector 109 mounted on each cylinder via a common rail 117, and directly jetted into the combustion chamber 106 from the fuel injector 109 in a prescribed timing in view of a crank angle (split injection according to the present embodiment as described later). The fuel jetted inside the combustion chamber 106 generates fuel-air mixture mixed with the intake air, and the fuel-air mixture is ignited and explosively combusted by a spark plug 111 actuated by ignition energy from an ignition coil 110. Then, the combustion waste gases (exhaust gases) is exhausted to an exhaust passage 140 via an exhaust valve 142 which is opened and closed by the exhaust camshaft 144.

One end (start point) of an EGR passage 112 is connected to the middle of the exhaust passage 140, and the other side of the EGR passage is connected to the intake air passage 130. An EGR control valve 113 and an EGR flow sensor 114 are arranged on the EGR passage 112, and a part of the exhaust gases (EGR gas) flowing through the exhaust passage 140 is refluxed to the intake air passage 130 via an EGR control valve 113 depending on necessity. The EGR flow rate is adjusted by the EGR control valve 113.

According to the present embodiment, an engine control module 101 in which a microcomputer is built in order to execute drive control of the above-mentioned fuel injector 109, throttle valve 104, ignition coil 110, high pressure fuel pump (solenoid) 108, EGR control valve 113, and so on.

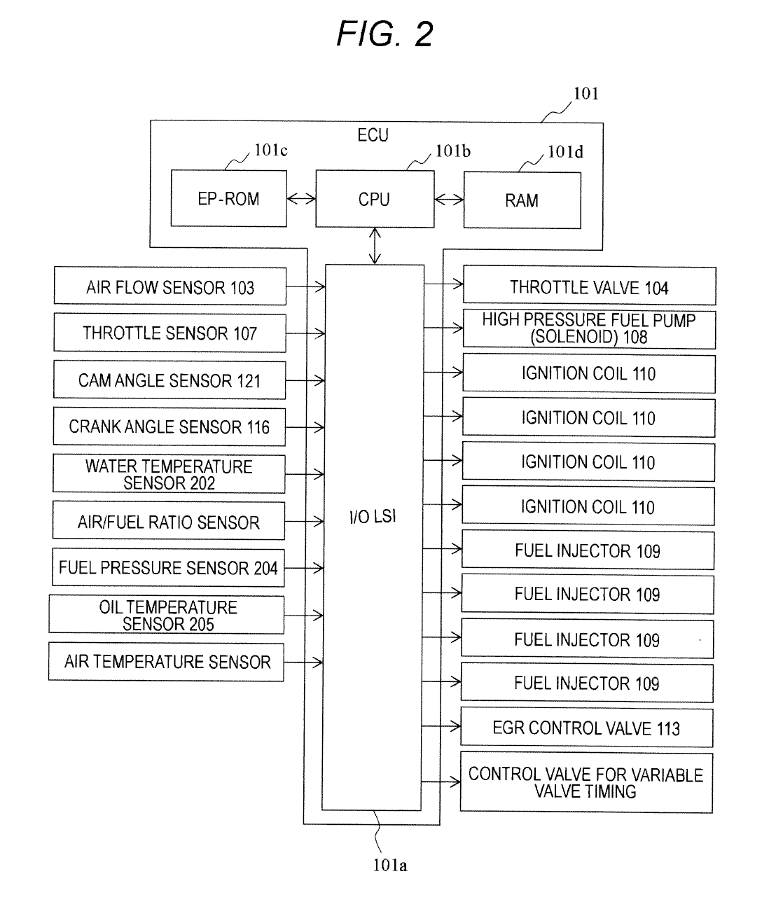

The engine control module 101 includes an I/O LSI 101a including an A/D converter, a CPU 101b, an EP-ROM 101c, an RAM 101d, etc. as shown in the internal configuration and an input and output relation illustrated thereof in FIG. 2. Signals are input from various kinds of sensors such as the air flow sensor 103, a throttle sensor 107, a cam angle sensor 121 attached to the intake camshaft 120, a crank angle sensor 116 attached to the crankshaft 115, a water temperature sensor 202, a fuel pressure sensor 204, an oil temperature sensor 205, an air/fuel ratio sensor, an intake air temperature (outside air temperature) sensor. Subsequently, prescribed computation processing is executed, and various control signals are output as computation results to execute drive control for the fuel injector 109, the throttle valve 104, the ignition coil 110, the high pressure fuel pump 108, the EGR control valve 113, etc. which are actuators.

According to the present embodiment, calculation is executed based on the signals from the crank angle sensor 116 and the cam angle sensor 121 to figure out, for example, which stroke of a single combustion cycle (intake stroke, compression stroke, expansion stroke, or exhaust stroke) each cylinder is, where a piston is positioned (e.g., the piston is positioned at how many degrees before the top dead center in the compress stroke in the crank angle view), and a lift position of the intake valve 119.

To control the fuel injection, the engine control module 101 calculates and sets an injection frequency (frequency of the split injection), an injection start timing, a split injection interval, a total injection time (total injected amount=total injection pulse width), etc. in a single combustion cycle.

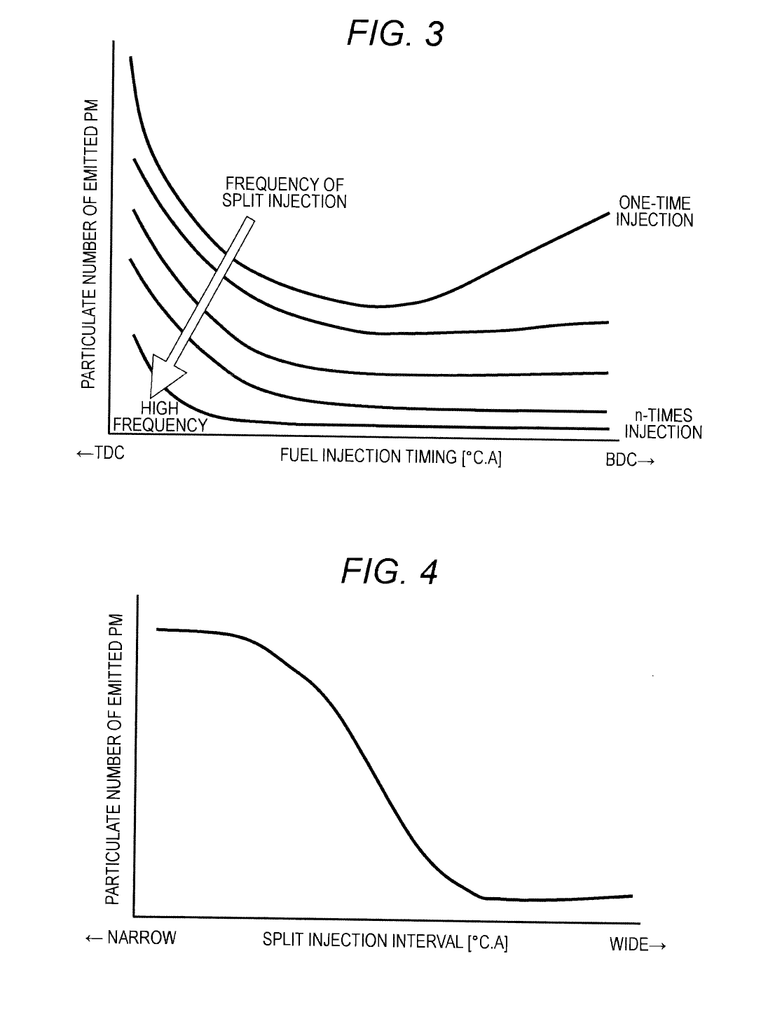

Next, a relation between the frequency of the split injection and the particulate number of the emitted PM will be described with reference to FIG. 3.

FIG. 3 illustrates the particulate number of the emitted PM relative to the number of split times in the case where the fuel amount required in a single combustion cycle is injected a plurality of split times. The more the number of split times is, the less the fuel injection amount in each injection is. Accordingly, fuel adhesion on a piston crown is reduced, and also the particulate number of the emitted PM is reduced.

Next, a relation between the split injection interval and the particulate number of the emitted PM is described with reference to FIG. 4.

In the case where the split injection interval is too narrow, effect of the split injection cannot be sufficiently obtained, and also the particulate number of the emitted PM cannot be reduced. Judging from FIG. 4, the injection interval has to be more than an interval of a prescribed crank angle in order to reduce the particulate number of the emitted PM.

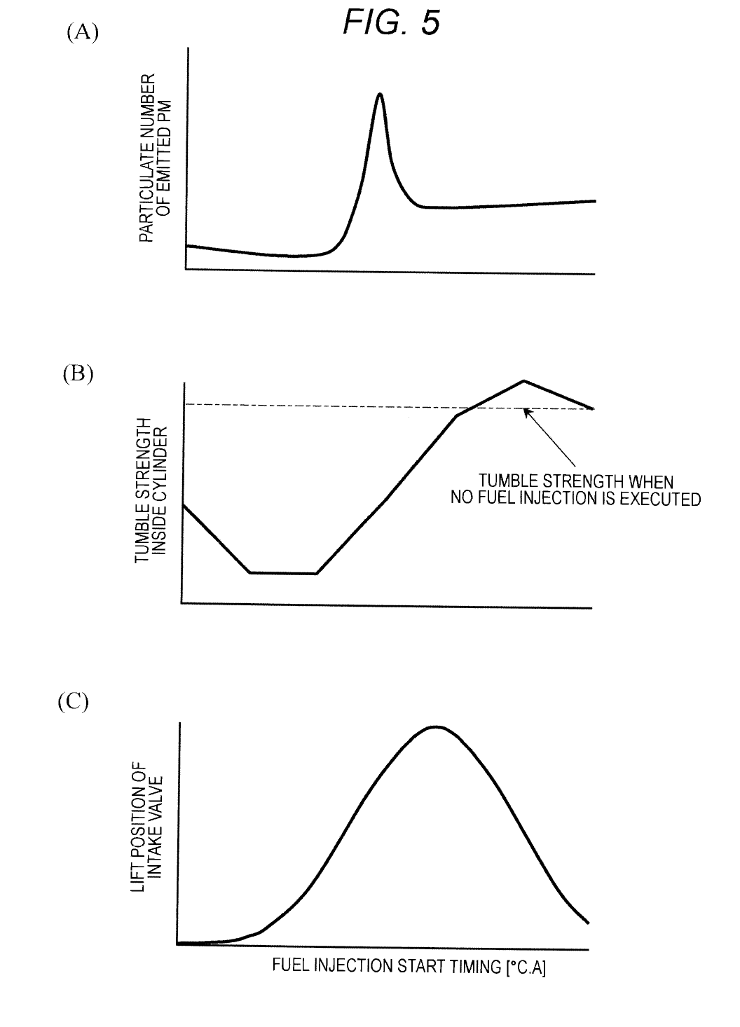

Next, relations between the fuel injection start timing and the particulate number of the emitted PM (A), between the fuel injection start timing and the tumble strength inside a cylinder (B), and between the fuel injection start timing and the intake valve lift position (C) will be described with reference to FIG. 5.

FIG. 5 illustrates the relations between the fuel injection start timing and the particulate number of the emitted PM (A), between the fuel injection start timing and the tumble strength inside a cylinder (B), and between fuel injection start timing and the intake valve lift position (C) in the case where the fuel is injected once in a single combustion cycle.

In contrast to the tumble strength inside the cylinder in the case where no fuel injection is executed, the tumble strength inside the cylinder increases and decreases depending on the fuel injection start timing in the case where the fuel is injected. This is because the air flow coming into the cylinder is controlled by the jetted fuel.

One of factors that increase the particulate number of the emitted PM is low homogeneity of the fuel-air mixture in which highly-concentrated fuel-air mixture is locally contained due to inhomogeneity of the fuel-air mixture. The stronger the tumble inside the cylinder is, the more the homogeneity of the fuel-air mixture can be improved.

In other words, the particulate number of generated PM is increased in the case where the fuel is jetted in the timing (period) in which the tumble is weakened. The same can be applied in the case where the amount of the fuel required in a single combustion cycle is injected a plurality of split times. Accordingly, in the event that any of fuel injection timing (period) coincides with the timing (period) in which the tumble is weakened, the particulate number of the generated PM is increased.

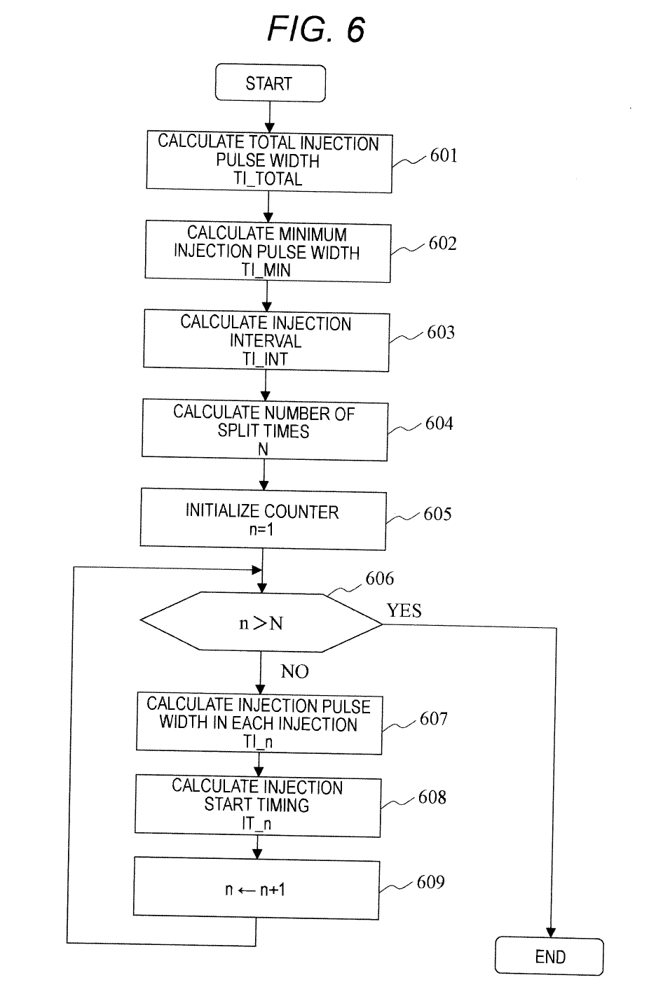

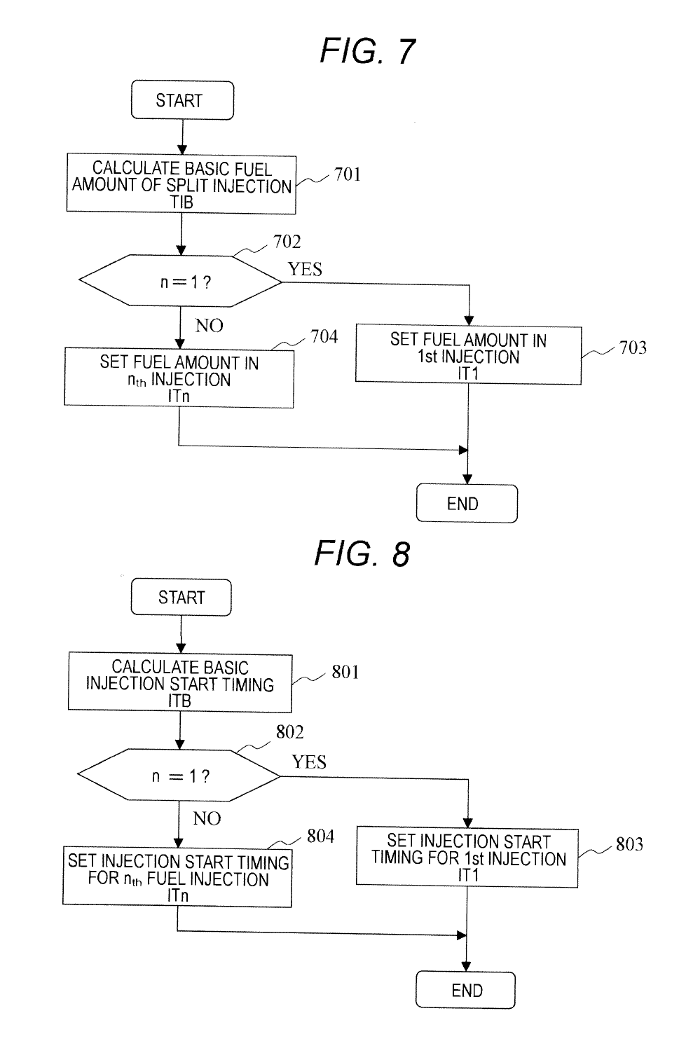

Next, contents of controlling of the split injection in the present embodiment will be concretely described with reference to FIGS. 6 and 7.

FIG. 6 is a flowchart of operations in controlling the split injection according to an embodiment of the present invention.

The operations illustrated in flowchart of FIG. 6 are interruption processings which are repeatedly executed, for example, in a cycle of 10 ms. The engine control module 101 obtains, by executing the processing illustrated in flowchart of FIG. 6, an injection pulse width and an injection pulse width and an injection start timing in each injection to each cylinder. Then, the engine control module 101 supplies, to each fuel injector 109, a drive pulse signal having the obtained injection pulse width in the injection start timing.

In step 601 of FIG. 6, a total injection pulse width TI_TOTAL, which is a total fuel amount to be injected from each fuel injector 109 in a single combustion cycle, is calculated. The total injection pulse width TI_TOTAL is set in accordance with an intake air amount per engine rotation calculated based on signals from the crank angle sensor 116 and the air flow sensor 103, an air/flow ratio set in accordance with, for example, operating condition, a fuel pressure calculated using a signal from the fuel pressure sensor 204, a cooling water temperature detected by the water temperature sensor 202, and so on.

In step 602, a minimum injection pulse width TI_MIN is calculated. Here, the minimum injection pulse width is set based on fuel pressure characteristics, electric characteristics, mechanical characteristics of the fuel injector 109, and other characteristics such as driving current waveform of the fuel injector.

In step 603, the injection interval which is an interval between the respective split injections, is calculated. The injection interval is set equal to or more than an interval of a prescribed crank angle, in view of the fuel adhesion, homogeneity of the fuel-air mixture, and securement of drive current for the fuel injector. In the case where the injection interval is too narrow, the fuel spay condition is substantially the same as one-time fuel injection. As a result, the effect of the split injection cannot be obtained, and the fuel adhesion on the piston crown and the cylinder bore wall surface may not be reduced. Moreover, in the fuel injector drive circuit, a voltage of a boosting circuit lowers every time the fuel injector is driven. Therefore, a time is required to recover the voltage back to the original voltage, and during this recovery time to boost the voltage, a next injection has to be held.

In step 604, the number of split times N is set. The number of split times N is determined by the engine rotation speed and a parameter indicating engine load condition.

In step 605, a counter n is initialized.

In step 606, it is determined whether a value of the counter n is larger than the number of the split times N. In the case where n is larger than N, the processing ends (setting for n=1 to N is completed). In the case the value of the counter n is equal to or smaller than the number of the split times N, the processing after the step 607 is performed.

In step 607, an injection pulse width TI_n (n=1 to N) for each injection is calculated. The details of step 607 are illustrated in FIG. 7.

In step 608, an injection start timing in each injection of the split injection is calculated. The details of step 608 are illustrated in FIG. 8.

In step 609, the value of counter n is incremented, and the processing returns to step 606. Thus, the above processing is repeated starting from n=1 to n=N, and the injection pulse width in each injection and the injection start timing in each injection are set.

Next, the details of step 607 in FIG. 6 (calculation of the injection pulse width in each injection) will be described with reference to FIG. 7.

In step 701, a basic injection pulse width TIB in each split injection is calculated. The total injection pulse width TI_TOTAL calculated in step 601 and the number of split times N calculated in step 604 are used to calculate the basic injection pulse width TIB by executing the division of TI_TOTAL/N.

In step 702, it is determined whether an injection is the first time injection (n=1) of the n times split injections in a single combustion cycle. In the case of n=1, the processing proceeds to step 703, and the fuel injection pulse width in the first time injection TI1 is set to TIB. In the case of n≠1 (injection after the first injection), the processing proceeds to step 704, and the fuel injection pulse width in the nₜₕ injection TIn is set to TIB. Here, the plurality of injections is split into an equal rate, but the split rate can be varied in accordance with the engine operating condition.

Next, the details of step 608 (calculation of the injection start timing) in FIG. 6 will be described with reference to FIG. 8.

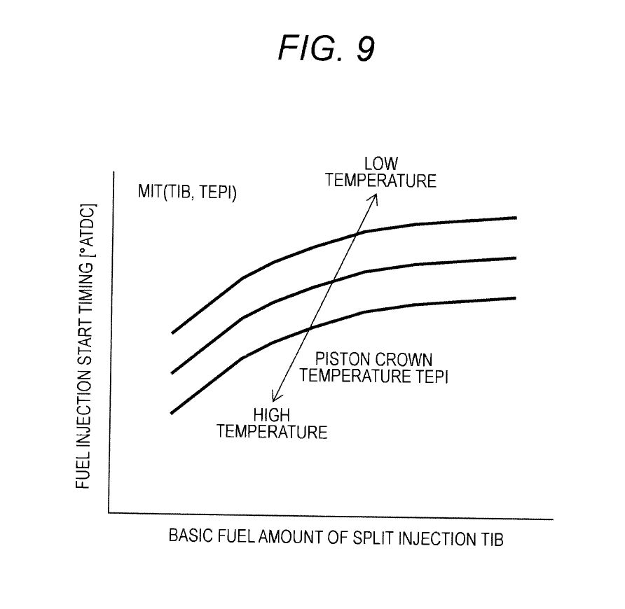

In step 801, the basic fuel amount of the split injection TIB calculated in step 701 of FIG. 7 and a piston crown temperature TEPI are input to calculate a basic injection start timing ITB with reference to a map MITB illustrated in FIG. 9. The map MITB is set in consideration of the amount of fuel adhesion due to the piston crown temperature TEPI and influence of a vaporizing rate. Additionally, it is a desirable method to estimate the crown temperature TEPI by configuring a thermal model using an amount of air, an air/flow ratio, ignition timing, and so on. However, from the viewpoint of simplification of the control, it is also acceptable to configure a map to search the crown temperature, using input values such as water temperature, oil temperature, intake air temperature detected by the water temperature sensor 202, the oil temperature sensor 205, and the air temperature sensor.

In step 802, it is determined whether setting is for the injection start timing in the first injection (possible angle) of the split injection in a single combustion cycle. In the case of n=1, the processing proceeds to step 803 in which the injection start timing for the first injection IT1 is set to ITB, and the processing ends. In the case of n≠1 (injection after the first time), the processing proceeds to step 804 in which the injection start timing for the nₜₕ injection (possible angle) ITn is calculated. The injection start timing for the nₜₕ injection (possible angle) IT_n is calculated by adding the injection pulse width after splitting the injection TI_(n−1) and the injection interval TI_INT calculated in step 603 of FIG. 6 to the previous injection start timing IT_(n−1).

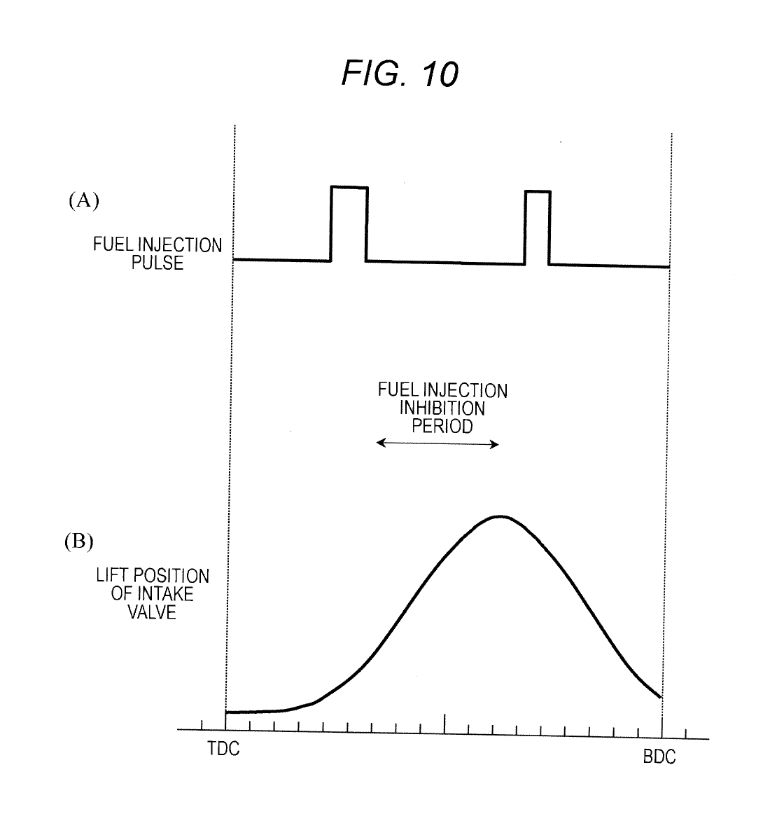

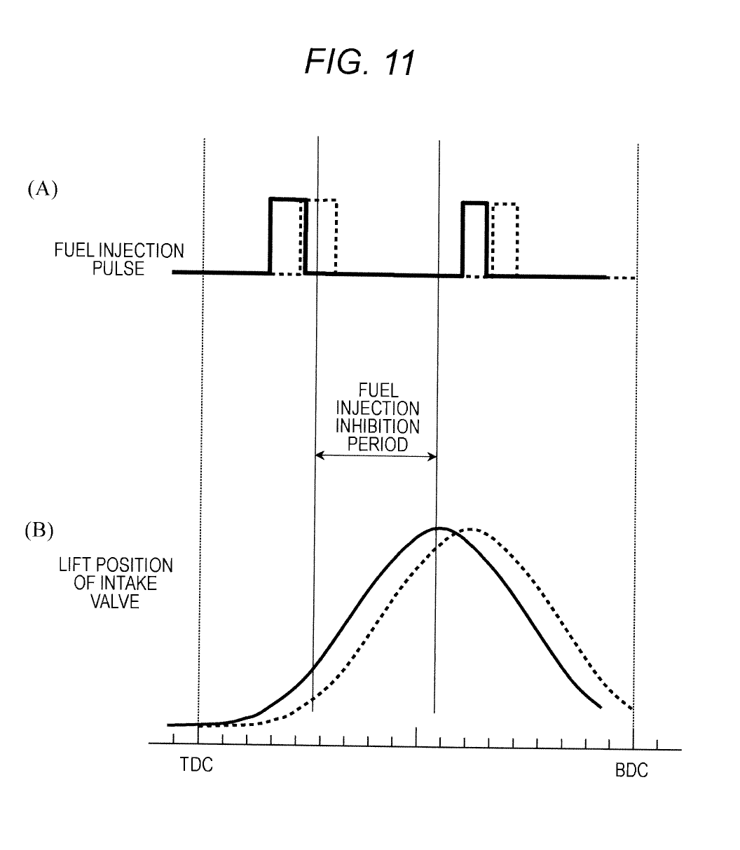

Next, concrete examples of control in the configurations as illustrated in FIGS. 6 to 9 will be described with reference to FIGS. 10 to 12.

FIG. 10 is an example of basic control according to an embodiment of the present invention. A fuel injection inhibition period is set in accordance with the lift position of the intake valve 119. The injection inhibition period indicates the range of the intake valve lift position, within which the tumble inside the cylinder is weakened by the fuel spray jetted into the combustion chamber 106. Therefore, the injection inhibition period is set to the range in which the lift position of the intake valve 119 is located from an middle lift position to the vicinity of a maximum lift position.

FIG. 11 is a control example in which timing of opening/closing the intake valve 119 is changed by a variable valve timing mechanism. The fuel injection inhibition period is always set in accordance with the lift position of the intake valve 119 even in the case where a valve-opening period illustrated in a dashed line is advanced to a valve-opening period illustrated in a solid line.

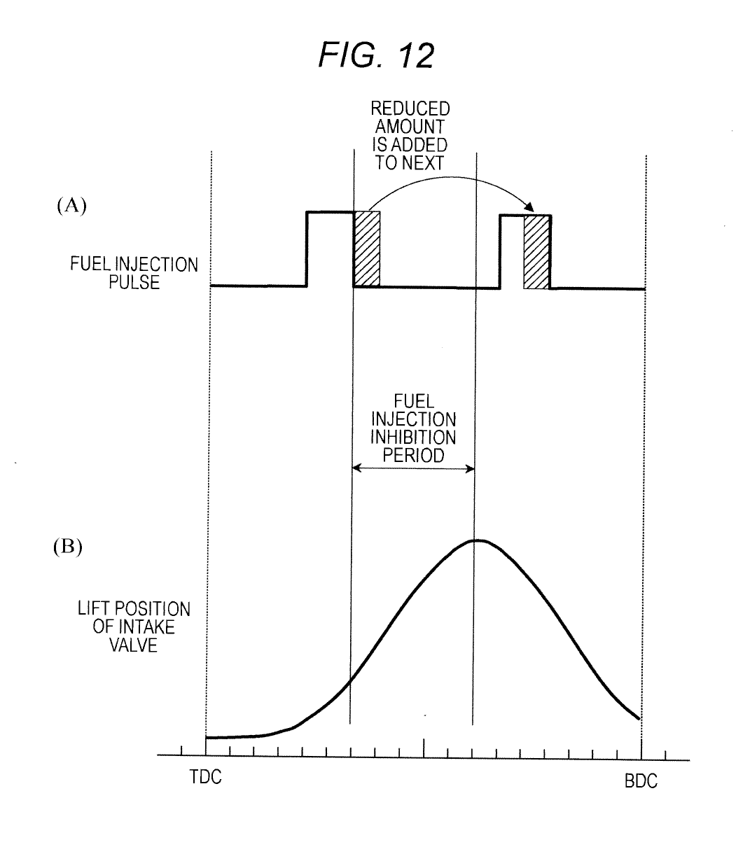

FIG. 12 is a control example in which the fuel injection starts before the fuel injection inhibition period, and the injection inhibition period starts coinciding with the middle of fuel injection because of a rapid operating condition change and the like. In the case where the injection inhibition period coincides with the fuel injection, the fuel injection is immediately stopped. The fuel amount reduced by stopping the fuel injection is added to a next injection executed after the injection inhibition period.

The above-described control prevents the tumble inside the cylinder from being weakened by the fuel spray jetted into the combustion chamber, and improves homogeneity of the fuel-air mixture inside the cylinder, and further the particulate number of the emitted PM can be reduced.

The embodiment of the present invention has been described above in detail, but it will be understood that the present invention is not limited thereto and various changes and modifications may be made without departing from the spirit of the present invention recited in the scope of the appended claims.

### REFERENCE SIGNS LIST

1 direct injection engine

101 engine control module

103 air flow sensor

104 throttle valve

106 combustion chamber

107 throttle sensor

108 high pressure fuel pump

109 fuel injector

110 ignition coil

111 spark plug

115 crankshaft

116 crank angle sensor

119 intake valve

120 camshaft

121 cam angle sensor

202 water temperature sensor

1.-4. (canceled)

5. A control device for a direct injection engine including a split injection control means configured to execute fuel injection a plurality of times in a single combustion cycle,
wherein the split injection control means executes the fuel injection by the split injection at least in an intake stroke, and inhibits the fuel injection for a period in which a lift position of an intake valve is within a predetermined range in a single combustion cycle.

6. The control device for a direct injection engine according to claim 5, wherein the split injection control means inhibits the fuel injection for a period in which the lift position of the intake valve is located from a middle lift position to the vicinity of a maximum lift position.

7. The control device for a direct injection engine according to claim 5, wherein the split injection control means executes at least a first fuel injection before the fuel injection inhibition period.

8. The control device for a direct injection engine according to claim 5, wherein the split injection control means starts the fuel injection before the fuel injection inhibition period, and in the case where the injection inhibition period starts coinciding with the fuel injection, the amount of the fuel reduced by the injection inhibition period is added to a subsequent fuel injection amount after the injection inhibition period.
